(19) United States
(12) Patent Application Publication
(10) Pub. No.: US 2026/0346371 A1
(43) Pub. Date: Nov. 5, 2026

(54) POWDER INJECTOR WITH A POSITIONING SECTION AND A STOP SECTION, JET NOZZLE WITH AN INNER WALL, AND SYSTEM WITH A JET NOZZLE AND POWDER INJECTORS

(71) Applicant: TRUMPF Laser- und Systemtechnik SE, Ditzingen (DE)

(72) Inventors: Stefan Belitz, Stuttgart (DE); Jakob Spiecker, Stuttgart (DE); Nicolai Speker, Pleidelsheim (DE); Bjoern Sautter, Leonberg (DE); Andreas Scholz, Taunusstein (DE)

(21) Appl. No.: 19/708,949

(22) Filed: Jun. 16, 2026

Related U.S. Application Data
(63) Continuation of application No. PCT/EP2024/084529, filed on Dec. 3, 2024.

(30) Foreign Application Priority Data
Dec. 20, 2023 (DE) 102023136141.4

(51) Int. Cl. B23K 26/144; B23K 26/14; B23K 26/34

(52) U.S. Cl. CPC B23K 26/144; B23K 26/1476; B23K 26/34

(57) ABSTRACT

A powder injector for insertion in an injector guide of a jet nozzle for laser cladding, including a first outer wall, a second outer wall, an injector tip located at a front in a powder conveying direction, and a hose interface located at a rear in the powder conveying direction. The injector tip has a positioning section in which the first outer wall of the powder injector is inclined relative to the powder conveying direction by a positioning chamfer. The injector tip has a stop section which adjoins the positioning section in the powder conveying direction and in which the second outer wall of the powder injector is inclined relative to the powder conveying direction by a stop chamfer that is different from the positioning chamfer and is less than 90°.

### CROSS REFERENCE TO RELATED APPLICATIONS

This application is a continuation of International Application No. PCT/EP2024/084529 (WO 2025/131694A1 ), filed on Dec. 3, 2024, and claims benefit to German Patent Application No. DE 10 2023 136 141.4, filed on Dec. 20, 2023. The aforementioned applications are hereby incorporated by reference herein.

### FIELD

The present invention relates to a powder injector for insertion into an injector guide of a jet nozzle for laser cladding, a jet nozzle for laser cladding and a system comprising a jet nozzle and a plurality of powder injectors.

### BACKGROUND

Laser cladding is used in the fields of repair, coating and/or joining technology, for example. A distinction may be drawn between conventional laser cladding (laser metal deposition (LMD), direct metal deposition (DMD) or direct energy deposition (DED)), and high-speed laser cladding (HS-LMD, for example in the form of extreme high-speed laser cladding (EHLA)). HS-LMD methods are described, for example, in published patent applications DE 10 2011 100 456 A and DE 10 2018 130 798 A1. Another method for laser cladding is known from the Chinese patent application CN 109175372 A.

A functional layer may be applied to a workpiece by means of laser cladding. This generally increases the load-bearing capacity of the workpiece processed by means of laser cladding relative to an unprocessed workpiece. The functional layer may serve as a wear protection layer, for example. The application of the functional layer may be based on a diffusion process, fusing and/or melting of a workpiece surface, an application of an additive material and a subsequent cooling so that a matrix structure with hard material particles is integrally bonded to the material surface. Laser cladding affects and alters the internal material structure of the workpiece and the material being applied.

### SUMMARY

In an embodiment, the present disclosure provides a powder injector for insertion in an injector guide of a jet nozzle for laser cladding, comprising a first outer wall, a second outer wall, an injector tip located at a front in a powder conveying direction, and a hose interface located at a rear in the powder conveying direction. The injector tip has a positioning section in which the first outer wall of the powder injector is inclined relative to the powder conveying direction by a positioning chamfer. The injector tip has a stop section which adjoins the positioning section in the powder conveying direction and in which the second outer wall of the powder injector is inclined relative to the powder conveying direction by a stop chamfer that is different from the positioning chamfer and is less than 90°.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a longitudinal section along a powder injector with a positioning chamfer, a stop chamfer, and a hose chamfer;

FIG. 2 shows a detail of a powder injector inserted into an injector guide of a jet nozzle;

FIG. 3 shows a plurality of powder injectors that can be used in a plurality of injector guides; and

FIG. 4 shows a jet nozzle, into the injector guides of which powder injectors are inserted.

### DETAILED DESCRIPTION

The present disclosure provides an improved powder injector for insertion into an injector guide of a jet nozzle for laser cladding, an improved jet nozzle for laser cladding and/or an improved system having a jet nozzle and a plurality of powder injectors. In particular, the present disclosure enables a more precise and/or lower-tolerance application of a powder jet to a workpiece. The present disclosure also facilitates the installation of a powder injector in an injector guide and/or to increase the robustness of the jet nozzle. Ultimately, the present disclosure also provides a higher-quality application of the functional layer.

Accordingly, a powder injector is provided for insertion into an injector guide of a jet nozzle for laser cladding. The powder injector conveys a powder jet containing at least one powdered additive material, which consists of or comprises hard material particles, in particular carbides, and a matrix material. The powdered additive material leaves the powder injector as a powder jet, which interacts with a laser beam and is applied to a workpiece to form a functional layer. On the side of the powder injector facing away from the workpiece, the powdered additive material is supplied to the powder injector via a hose and/or a powder supply line. The jet nozzle can have a light channel for guiding at least one laser beam directed at the workpiece. Furthermore, the jet nozzle can have a powder unit, arranged radially outside the light channel, for guiding at least one powder jet in a powder conveying di-rection. The powder unit can have a plurality of injector guides in a circumferential direction of the jet nozzle, into each of which guides a powder injector is inserted. The plurality of injector guides can extend at least partially around the light channel in the circumferential direction. For example, the injector guides are arranged around the light channel in the manner of a partial circle. The powder injector can be inserted into an injector guide in a form-fitting manner. Additionally, the powder injector can be fixed frictionally in the injector guide.

The powder injector has an injector tip located at the front in the powder conveying direction and a hose interface located at the rear in the powder conveying direction. The powder conveying direction indicates the direction in which the powdered additive material is guided through the powder injector. It corresponds to a longitudinal axis of the powder injector, which, in the case that the powder injector is rotationally symmetrical, corresponds to the axis of rotation. The powder conveying direction corresponds to the longitudinal axis of the injector guide. The injector tip is a section of the powder injector that faces the workpiece. The injector tip can be less than one tenth the length of the powder injector. The injector tip is the section of the powder injector facing the processing location, which is why it is exposed to the highest thermal load. At the injector tip, the powdered additive material leaves the powder injector as a powder jet from an outlet opening. The hose interface is a section of the powder injector that faces away from the workpiece. The hose interface can be less than one twentieth the length of the powder injector. The powdered additive material is supplied to the powder injector at the hose interface.

The injector tip has a positioning section in which an outer wall of the powder injector is inclined relative to the powder conveying direction by a positioning chamfer. The positioning chamfer reduces the outer diameter of the powder injector in the region of the injector tip. The positioning chamfer facilitates radial positioning of the powder injector in the injector guide. An inner wall of the jet nozzle can be tapered in the powder conveying direction, roughly in the manner of a first section, in order to radially accommodate the positioning section. The positioning chamfer can be machined onto the powder injector.

The injector tip has a stop section which adjoins the positioning section in the powder conveying direction and in which an outer wall of the powder injector is inclined relative to the powder conveying direction by a stop chamfer that is different from the positioning chamfer and is less than 90°. The stop chamfer causes the outer diameter of the powder injector to decrease further after the positioning section. The stop chamfer facilitates axial positioning of the powder injector in the injector guide. The inner wall of the jet nozzle can have a stop to axially accommodate the stop section. The stop chamfer can be machined onto the powder injector. The fact that the stop chamfer is less than 90° means that the angle between a chord bearing against the stop section and the powder conveying direction is less than 90°, so that the stop section is pointed in the powder conveying direction.

The interaction between the positioning section and the stop section ensures a separation of functions when the powder injector is inserted into the injector guide. The depth stop is achieved via the stop section, and the radial positioning via the positioning section. The positioning of the powder injector in the jet nozzle is thus precisely defined, resulting in fewer tolerances. The actual position of the powder injector in the jet nozzle corresponds substantially without tolerance to the theoretical position, which enables a more precise and/or lower-tolerance application of the powder jet to a workpiece. Furthermore, the separation of functions ensures efficient installation of the powder injector, avoiding a loose mounting of the powder injector in the injector guide, which can result from a statically overdetermined design. In particular, the stop section rests without gaps on a stop of the injector guide. The positioning chamfer and the stop chamfer mean that the powder injector is tapered in the region of the injector tip, resulting in it having less material than a powder injector without a positioning chamfer and stop chamfer. This reduction in material leads to decreased thermal loading of the powder injector, since less thermal energy can be transferred from the processing location to the powder injector. This improves the lifespan of the powder injector. Furthermore, the positioning section has a chamfered shoulder to absorb axial forces, which further reduces the minimum distance between an outlet opening of the powder injector and a nozzle tip of the jet nozzle. Ultimately, the positioning section with the positioning chamfer allows for the elimination of a massive shoulder in the injector guide, making it possible to bring the powder injector closer to the processing location, which increases the precision of the powder jet and thus promotes a higher-quality application of the functional layer.

In an embodiment, the positioning chamfer is in a range between 5° and 45°, in particular between 15° and 25°. It has been found that within this angular range an optimal compromise is achieved between (1) satisfactory radial guidance, (2) sufficient wall thick-ness of the powder injector to withstand thermal and/or mechanical loads, (3) sufficient ab-sorption of axial forces when the positioning chamfer rests on a corresponding section of the injector guide, (4) efficient manufacturing of the injector guide and the powder injector, (5) space utilization in the region of a nozzle mouth of the jet nozzle and/or (6) bringing the individual powder injectors close to the processing location. Therefore, the positioning chamfer in this angular range contributes to increasing the efficiency and precision of processing by the powder injector.

In an embodiment, the stop chamfer is in a range between 45° and 85°, in particular between 60° and 80°. It has been found that within this angular range an optimal compromise is achieved between (1) a satisfactory depth stop, (2) sufficient wall thickness of the powder injector to withstand thermal and/or mechanical loads, (3) sufficient absorption of axial forces when the stop chamfer rests on a corresponding stop of the injector guide, (4) efficient manufacturing of the injector guide and the powder injector, (5) space utilization in the region of the nozzle mouth of the jet nozzle and/or (6) bringing the individual powder injectors close to the processing location. Therefore, the stop chamfer in this angular range contributes to increasing the efficiency and precision of processing by the powder injector.

In an embodiment, an inner wall of the hose interface is inclined relative to the powder conveying direction by a hose chamfer, which is inclined in particular in a range between 30° and 80° and further in particular between 40° and 60°. This hose chamfer enables a continuous transition between the inner diameter of a powder supply line and the inner diameter of a conveying shaft running between the injector tip and the hose interface. Accordingly, reduced turbulence occurs during the transition of the powdered additive material from the powder supply line into the powder injector, which improves the flow characteristics of the powder conveyance.

In an embodiment, the powder injector further comprises the conveying shaft which extends in the powder conveying direction between the injector tip and the hose interface in order to convey a medium, in particular a powder and/or a powder mixture, i.e. the powdered additive material, through the powder injector, and the conveying shaft has a substantially constant cross-section. The conveying shaft can have a constant inner diameter and a constant outer diameter. This further improves the flow characteristics of the powder conveyance and simplifies the production of the conveying shaft.

In an embodiment, the injector tip has an end ring that closes off the stop section in the powder conveying direction, the diameter of said end ring exceeding an inner diameter of the conveying shaft of the powder injector. The end ring constitutes the distal boundary of the powder injector, i.e. the boundary facing the workpiece. Because the end ring has a diameter that exceeds the inner diameter of the conveying shaft, the exit of the powdered additive material from the powder injector is promoted, since a geometry of a developing powder jet cone is predetermined. The resulting powder jet cone can be adapted to the intended processing and powder focus via the geometry of the end ring. This improves the precision of the processing using the powder jet.

In an embodiment, the injector tip comprises less than one tenth the length of the powder injector in the powder conveying direction. Alternatively or additionally, the hose interface makes up less than one twentieth the length of the powder injector in the powder conveying direction. The majority of the length of the powder injector can thus be formed by the conveying shaft, which promotes efficient conveyance of the powdered additive material through the powder injector.

In an embodiment, the length of the positioning section in the powder conveying direction exceeds the length of the stop section by a factor of at least four. In particular, in the powder conveying direction, 90% of the injector tip is formed by the positioning section, and the remaining 10% by the stop section. It has been shown that this ratio allows for a reliable division of the functions. Furthermore, a relatively short length of the stop section allows the powder injector to be brought closer to the processing location, which has a positive effect on the precision of laser cladding.

In an embodiment, the powder injector is made of a non-magnetic hard metal, in particular in one piece. This enables the efficient conveying of the powdered additive material due to the absence of magnetic effects. Furthermore, it simplifies the production of the powder injectors themselves.

Furthermore, a jet nozzle for laser cladding can be provided, which works in conjunction with the powder injector to achieve the disclosed advantages. The jet nozzle has a light channel for guiding at least one laser beam, which is directed at a workpiece. Laser cladding can be a method for high-speed laser cladding (HS-LMD) in a direction of advance. The direction of advance is the direction in which the jet nozzle moves relative to the workpiece. It can result from a movement, in particular a rotational movement, of the work-piece, from a movement of the jet nozzle or from a superposition of both movements. The direction of advance and the correlating advancement movement can be constant over the course of the process. Alternatively, they can vary with the process stage. The workpiece can be a rotationally symmetrical workpiece, such as a brake disk, a hydraulic cylinder, a pressure roller or a plain bearing. The laser beam can radiate through the light channel. It can be provided by a laser source, from which the laser beam is guided by means of an optical fiber cable to a laser system that splits the laser beam via a collimating lens and focuses it in line with the process via a laser optical unit before it enters the jet nozzle. The light channel can be a hollow channel that runs through the entire jet nozzle in a longitudinal direction. In addition to the laser beam, a process gas can also be directed to the workpiece sur-face through the light channel.

The jet nozzle furthermore has a powder unit, arranged radially outside the light channel, for guiding at least one powder jet in a powder conveying direction. The powder conveying direction indicates the direction in which a powdered additive material is guided. The powder jet can be applied to the workpiece at least with a first powder focus. Starting from the longitudinal direction of the jet nozzle, the powder unit can be radially outside the light channel and can be part of an outer structure that surrounds the light channel in a closed manner. The powder jet can carry at least one powdered additive material consisting of or comprising hard material particles, in particular carbides, and a matrix material. The powder unit can be the part of the jet nozzle that is provided to at least indirectly guide the powdered additive material. The powder jet is completely or partially focused on the first powder focus. The first powder focus is the point at which the powder unit directs the powder jet. The first powder focus can be eccentric with respect to a center of the light channel. The jet nozzle can also direct the powder jet at a plurality of powder foci.

The powder unit has a plurality of injector guides, into each of which a powder injector can be inserted. An injector guide can serve as a receptacle for a powder injector. The injector guides can be introduced into the powder unit by means of machining. Alter-natively, they are additively manufactured. The injector guides can be adapted to the powder injector to be inserted. The jet nozzle can have at least two injector guides that are opposite each other. In particular, it can have four or more injector guides. The plurality of injector guides can be closed in the circumferential direction of the jet nozzle or arranged in the manner of a partial circle or in the manner of a partial elongated hole.

At least one, and in particular every, injector guide has an inner wall contour that tapers at least partially in the powder conveying direction to accommodate a positioning portion of the powder injector. The powder conveying direction indicates the direction in which the powdered additive material is guided through the powder injector. The taper can be an at least partially continuous reduction in the diameter of the inner wall contour. It can have a step that separates a first section, prepared to accommodate the positioning section, from a second section, prepared to accommodate the stop section.

The taper constitutes a chamfered shoulder to absorb axial forces from the powder injector, thus reducing the minimum distance between the outlet opening of the powder injector and the nozzle tip of the jet nozzle. The taper allows for the elimination of a massive shoulder in the injector guide, making it possible to bring the powder injector closer to the processing location, which increases the precision of the powder jet and thus promotes a higher-quality application of the functional layer.

In an embodiment, the inner wall contour has a stop that is inclined at less than 90° relative to the powder conveying direction in order to accommodate a stop section of the powder injector. The stop can have an angle relative to the powder conveying direction that can correlate with a cutting angle of a drill bit that drills into the injector guide, and is, for example, 70°. This allows for a gap-free depth stop between the injector guide and the powder injector. Furthermore, the stop enables the powder injector to be shielded from the reflection of laser radiation from the workpiece being processed. The interaction between the positioning section and the stop section ensures a separation of functions when the powder injector is inserted into the injector guide. The depth stop is achieved via the stop section, and the radial positioning via the positioning section. The positioning of the powder injector in the jet nozzle is thus precisely defined, resulting in fewer tolerances. The actual position of the powder injector in the jet nozzle corresponds substantially without tolerance to the theoretical position, which enables a more precise and/or lower-tolerance application of the powder jet to a workpiece. Furthermore, the separation of functions ensures efficient installation of the powder injector, avoiding a loose mounting of the powder injector in the injector guide, which can result from a statically overdetermined design.

In an embodiment, the inclination of the taper corresponds at least partially, in particular in a first section, to a positioning chamfer of the powder injector and/or the inclination of the stop corresponds at least partially, in particular in the case of a stop, to a stop chamfer of the powder injector. The taper can be at least partially in a range between 5° and 45°, in particular between 15° and 25°. The inclination of the stop can initially be partially, in particular in the first section, in a range between 45° and 85°, in particular between 60° and 80°. This further contributes to enabling efficient, robust and cost-effective insertion of the powder injector into the injector guide and also increases the quality of the powder supply.

In an embodiment, at least one, in particular each, of the plurality of injector guides is drilled. In particular, a finishing of the bore in the form of additional milling is not necessary, since the stop can be formed according to a cutting angle of an inserted drill bit, for example 70°.

The disclosure further relates to a system having a jet nozzle, in particular having the features of the present disclosure, and a plurality of powder injectors for guiding at least one powder jet in a powder conveying direction, in particular having the features of the present disclosure, wherein one powder injector is inserted into each injector guide of the jet nozzle. An injector tip of a first powder injector, located at the front in the powder conveying direction, has a distance to an injector tip of an adjacent powder injector that is less than twice the wall thickness of a conveying shaft of the powder injector. Such a close arrangement of two adjacent powder injectors can be made possible by the positioning section of the powder injector in interaction with the tapering of the injector guide. It allows the system to be implemented in a space-saving manner with a high functional density. Furthermore, the powder focus of the powder injectors can be adjusted efficiently and with low tolerance due to the close spatial relationships between them.

Preferred further embodiments of the present disclosure are explained in greater detail by the following description of the figures.

Preferred exemplary embodiments are described below with reference to the figures. In this respect, elements that are the same, similar, or have the same effect are provided with identical reference signs in the various figures, and a repeated description of these elements is omitted in some instances to avoid redundancies.

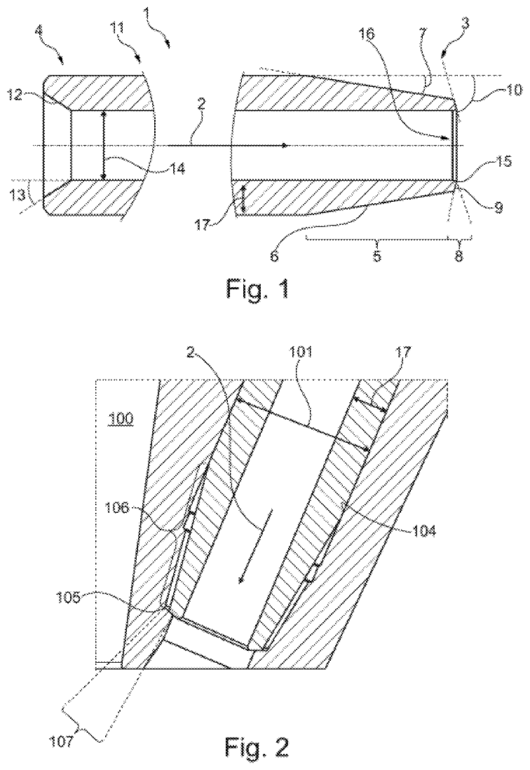

FIG. 1 shows a powder injector 1 for insertion into an injector guide 101 of a jet nozzle 100 (see FIG. 4). In a powder conveying direction 2, an injector tip 3 is located at the front, and a hose interface 4 is located at the rear. The injector tip 3 has a positioning section 5 in which an outer wall 6 is inclined relative to the powder conveying direction by a positioning chamfer 7. The injector tip 3 also has a stop section 8 which adjoins the positioning section 5. An outer wall 9 of the stop section 8 is inclined relative to the powder conveying direction 2 by a stop chamfer 10 which differs from the positioning chamfer 7, the stop chamfer 10 being less than 90°.

Between the injector tip 3 and the hose interface 4 there is a conveying shaft 11. The conveying shaft 11 is shaped in the manner of a hollow tube with a constant wall thickness. The conveying shaft 11 has a substantially constant cross-section. The hose interface 4 has an inner wall 12 which is inclined relative to the powder conveying direction 2 by a hose chamfer 13. The hose chamfer 12 ensures a continuous transition between an inner diameter of a supply line for the powdered additive material and an inner diameter 14 of the conveying shaft 11. The continuous transition of the powdered additive material into the powder injector 1 minimizes friction between the powdered additive material and the pow-der injector 1 by preventing turbulence.

The injector tip 3 has an end ring 15. This constitutes the section of the powder injector 1 that is furthest forward in terms of conveying throughput 2. The diameter of the end ring 15 exceeds the inner diameter 14 of the conveying shaft 11. In this way, the injector tip 3, in particular the stop section 8, widens the inner diameter 14 of the conveying shaft 11, which promotes the exit of the powder jet from the powder injector 1 in the form of a powder cone. The outlet opening 16 of the powder injector 1 therefore has a smaller diameter than the end ring 15. The conveying shaft 11 has a wall thickness 17 which is substantially constant. The wall thickness of the injector tip 3 is less than the wall thickness 17 of the conveying shaft due to the positioning chamfer 7 and the stop chamfer 10. Accordingly, the wall thickness of the hose interface 4 is less than the wall thickness 17 of the conveying shaft due to the inclined inner wall 12 of the hose interface 4.

FIG. 2 shows the powder injector 1 inserted into a jet nozzle 100. The jet nozzle 100 has a plurality of injector guides 101, into each of which a powder injector 1 is inserted. The jet nozzle 100 also has a light channel 102 for guiding at least one laser beam directed at a workpiece (see FIG. 4). Radially outside the light channel 102, a powder unit 103 is arranged for guiding at least one powder jet in the powder conveying direction 2. The powder unit 103 has a plurality of injector guides 101. Each injector guide 101 has an inner wall contour 104 which tapers at least partially in the powder conveying direction 2 in order to accommodate the positioning section 5 of the powder injector 1.

The tapering can be an at least partially continuous reduction in diameter of the inner wall contour 104. It can have a step 105 which separates a first section 106, which is prepared to accommodate the positioning section 5, from a second section in the manner of a stop 107, which is prepared to accommodate the stop section 8. The first section 106 can be inclined relative to the powder conveying direction 2 in such a way that it correlates with the positioning chamfer 7. For example, the inclination of the first section 106 can be in a range between 5° and 45°, in particular between 15° and 25°. Accordingly, the stop 107 can be inclined relative to the powder conveying direction 2 in such a way that it correlates with the stop chamfer 10. For example, the inclination of the stop 107 can be in a range between 45° and 85°, in particular between 60° and 80°. The first section 106 constitutes a chamfered shoulder for absorbing axial forces of the powder injector 1, which reduces the minimum distance between the outlet opening 16 of the powder injector 1 and a nozzle tip of the jet nozzle 100. The tapering allows for the elimination of a massive shoulder in the injector guide 101, making it possible to bring the powder injector 1 closer to the processing location, which increases the precision of the powder jet and thus promotes a higher-quality ap-plication of the functional layer.

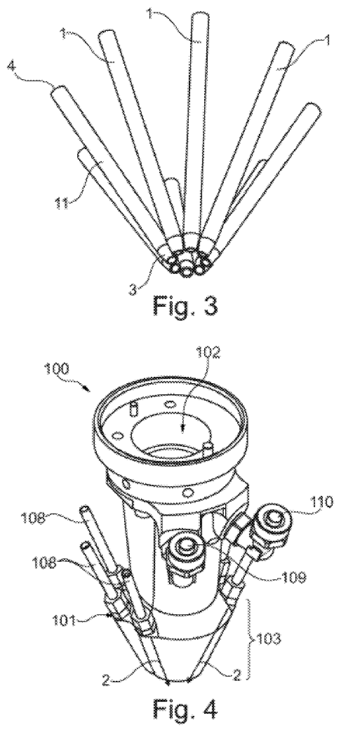

FIG. 3 shows the plurality of powder injectors 1 in an arrangement in a jet nozzle. The injector tip 3 has a length in the powder conveying direction 2 that is less than one tenth of the length of the powder injector 1. The hose interface 4 has a length in the powder conveying direction which is less than one twentieth the length of the powder injector 1. The positioning section 5 and its interaction with the first section 106 of the jet nozzle 100 make it possible to minimize the distance between two adjacent powder injectors 1 in the region of the injector tip 3 in a circumferential direction. The distance between two adjacent powder injectors 1 is less than twice the wall thickness 17 of the conveying shaft 11 of the powder injector.

FIG. 4 shows the jet nozzle 100, in the injector guides 101 of which a powder injector 1 is inserted. Each powder injector 1 is connected to a powder supply line 108. These provide the powder injector 1 with the powdered additive material, so that it is conveyed to the processing location in an inclined manner with respect to the axis of the light channel 102. The powder injectors 1 adjoin the powder supply lines 108 in the region of the nozzle mouth 103. The jet nozzle 100 also has a cooling channel which is part of a cooling circuit via a supply line 109 and a discharge line 110.

Insofar as applicable, all individual features presented in the exemplary embodiments can be combined with one another and/or interchanged, without departing from the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Powder injector
2 Powder conveying direction
3 Injector tip
4 Hose interface
5 Positioning section
6 Outer wall of the positioning section
7 Positioning chamfer
8 Stop section
9 Outer wall of the stop section
10 Stop chamfer
11 Conveying shaft
12 Inner wall of the hose interface
13 Hose chamfer
14 Inner diameter of the conveying shaft
15 End ring
16 Outlet opening
17 Wall thickness of the conveying shaft
100 Jet nozzle
101 Injector guide
102 Light channel
103 Powder unit
104 Inner wall contour
105 Step
106 First section
107 Stop
108 Powder supply line

1. A powder injector for insertion in an injector guide of a jet nozzle for laser cladding, comprising:
a first outer wall;
a second outer wall;
an injector tip located at a front in a powder conveying direction; and
a hose interface located at a rear in the powder conveying direction,
wherein the injector tip has a positioning section in which the first outer wall of the powder injector is inclined relative to the powder conveying direction by a positioning chamfer, and
wherein the injector tip has a stop section which adjoins the positioning section in the powder conveying direction and in which the second outer wall of the powder injector is inclined relative to the powder conveying direction by a stop chamfer that is different from the positioning chamfer and is less than 90°.

2. The powder injector according to claim 1, wherein the positioning chamfer is in a range between 5° and 45°.

3. The powder injector according to claim 1, wherein the stop chamfer is in a range between 45° and 85°.

4. The powder injector according to claim 1, wherein an inner wall of the hose interface is inclined relative to the powder conveying direction by a hose chamfer, which is inclined in a range between 30° and 80°.

5. The powder injector according to claim 1, further comprising a conveying shaft extending in the powder conveying direction between the injector tip and the hose interface, the conveying shaft being configured to convey a powder and/or powder mixture through the powder injector, wherein the conveying shaft has a constant cross-section.

6. The powder injector according to claim 1, wherein the injector tip has an end ring which terminates the stop section in the powder conveying direction and which has a diameter exceeding an inner diameter of a conveying shaft of the powder injector.

7. The powder injector according to claim 1, wherein the injector tip is less than one tenth a length of the powder injector and/or wherein the hose interface is less than one twentieth a length of the powder injector.

8. The powder injector according to claim 1, wherein a length of the positioning section in the powder conveying direction exceeds a length of the stop section by a factor of at least four.

9. The powder injector according to claim 1, wherein the powder injector is configured to be formed from a non-magnetic hard metal in one piece.

10. A jet nozzle for laser cladding, comprising:
a light channel configured to guide at least one laser beam directed onto a workpiece; and
a powder unit, arranged radially outside the light channel, configured to guide at least one powder jet in a powder conveying direction,
wherein the powder unit has a plurality of injector guides into which the powder injector according to claim 1 is configured to be inserted, and
wherein each injector guide has an inner wall contour which tapers at least partially in the powder conveying direction to accommodate a positioning section of the powder injector.

11. The jet nozzle according to claim 10, wherein the inner wall contour has a stop which is inclined at less than 90° relative to the powder conveying direction to accommodate a stop section of the powder injector.

12. The jet nozzle according to claim 10, wherein an inclination of the inner wall contour corresponds at least partially to the positioning chamfer of the powder injector.

13. The jet nozzle according to claim 10, wherein each of the plurality of injector guides is drilled.

14. A system comprising:
a jet nozzle comprising a light channel configured to guide at least one laser beam directed onto a workpiece and a powder unit arranged radially outside the light channel, the powder unit having a plurality of injector guides; and
a plurality of powder injectors each configured according to the powder injector according to claim 1, wherein one of the plurality of powder injectors is inserted into each of the plurality of injector guides of the jet nozzle,
wherein the injector tip of a first powder injector of the plurality of powder injectors located at the front in the powder conveying direction has a distance to the injector tip of an adjacent powder injector of the plurality of powder injectors which is less than twice a wall thickness of a conveying shaft of the first powder injector.

15. The powder injector according to claim 2, wherein the positioning chamfer is between 15° and 25°.

16. The powder injector according to claim 3, wherein the stop chamfer is between 60° and 80°.

17. The powder injector according to claim 4, wherein the hose chamfer is between 40° and 60°.

18. The jet nozzle according to claim 11, wherein an inclination of the stop corresponds at least partially to the stop chamfer of the powder injector.
